(19) United States
(12) Patent Application Publication
(10) Pub. No.: US 2024/0333908 A1
(43) Pub. Date: Oct. 3, 2024

(54) IMAGE PROCESSING APPARATUS, IMAGE PROCESSING METHOD, AND NON-TRANSITORY COMPUTER-READABLE MEDIUM

(71) Applicant: CANON KABUSHIKI KAISHA, Tokyo (JP)

(72) Inventor: KINA ITAKURA, Kanagawa (JP)

(21) Appl. No.: 18/620,593

(22) Filed: Mar. 28, 2024

(30) Foreign Application Priority Data
Mar. 31, 2023 (JP) 2023-059529

(51) Int. Cl. H04N 13/398; G06F 3/14; G06V 10/44

(52) U.S. Cl. CPC H04N 13/398; G06F 3/14; G06V 10/44

(57) ABSTRACT

An image processing apparatus includes a video image obtaining unit configured to obtain video data corresponding to a stereo video image including a left-eye image and a right-eye image, and a control unit configured to control guide information and the stereo video image to be displayed based on the video data, the guide information varying depending on a position on the stereo video image and indicating a deviation between the left-eye image and the right-eye image in a vertical direction.

### BACKGROUND

### Technical Field

The present disclosure relates to an image processing technique for correcting a stereo video image.

### Description of the Related Art

A display device configured to display a video image (hereinafter referred to as a “stereo video image”) composed of a left-eye video image and a right-eye video image that differ from each other is commercially available as a display device to be used for a viewer to enjoy viewing a stereoscopic video image. One form of such a display device is a head-mounted display (HMD) that enables a viewer wearing the HMD on his or her head to enjoy a video image with realistic sensation. Another form of such a display device is a camera that includes two fisheye lenses and is configured to easily capture a stereo video image in a 180-degree range in front of the viewer from two viewpoints, thereby obtaining a stereo video image that provides a 180-degree stereoscopic view in front of the viewer.

In the HMD, a difference between the position of an object included in the left-eye video image in the stereo video image and a display position of the object included in the right-eye video image in a vertical direction may cause eyestrain, fusion disability, or the like of the viewer.

Japanese Patent Application Laid-Open No. H11-27703 discusses a technique for correcting a deviation of a stereo video image in the vertical direction using a user interface that receives a correction amount for correcting the deviation of the stereo video image in the vertical direction from a user.

### SUMMARY

According to an aspect of the present disclosure, an image processing apparatus includes a video image obtaining unit configured to obtain video data corresponding to a stereo video image including a left-eye image and a right-eye image, and a control unit configured to control guide information and the stereo video image to be displayed based on the video data, the guide information varying depending on a position on the stereo video image and indicating a deviation between the left-eye image and the right-eye image in a vertical direction.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration example of an image processing apparatus according to a first exemplary embodiment.

FIG. 2 is a block diagram illustrating a functional configuration example of the image processing apparatus.

FIG. 3 is a flowchart illustrating a processing flow of the image processing apparatus.

FIGS. 4A and 4B each illustrate an outline of a display screen.

FIGS. 5A and 5B each illustrate a difference in viewing state between viewing with a head-mounted display (HMD) and capturing of a stereo video image.

FIG. 6 illustrates a configuration example on a display screen.

FIG. 7 is a block diagram illustrating a functional configuration example of an image processing apparatus according to a second exemplary embodiment.

FIG. 8 is a flowchart illustrating a processing flow of the image processing apparatus according to the second exemplary embodiment.

FIG. 9 is a block diagram illustrating a functional configuration example of an image processing apparatus according to a third exemplary embodiment.

FIG. 10 is a flowchart illustrating a processing flow of the image processing apparatus according to the third exemplary embodiment.

### DESCRIPTION OF THE EMBODIMENTS

Exemplary embodiments of the present disclosure will be described below with reference to the drawings. The following exemplary embodiments are not intended to limit the present disclosure, and not all combinations of features described in the exemplary embodiments are necessarily essential to the solution of the present disclosure. The same components are denoted by the same reference numerals.

According to the technique discussed in Japanese Patent Application Laid-Open No. H11-27703, it is difficult for a user to recognize whether a deviation in a vertical direction is appropriately corrected with a correction amount designated by the user. In this regard, in a first exemplary embodiment, a method for displaying a guideline on a stereo video image according to a cursor position pointed by the user on a display screen in the case of correcting the position of a camera that has captured left and right video images included in the stereo video image as video data will be described. The outline and significance of the present exemplary embodiment will now be described.

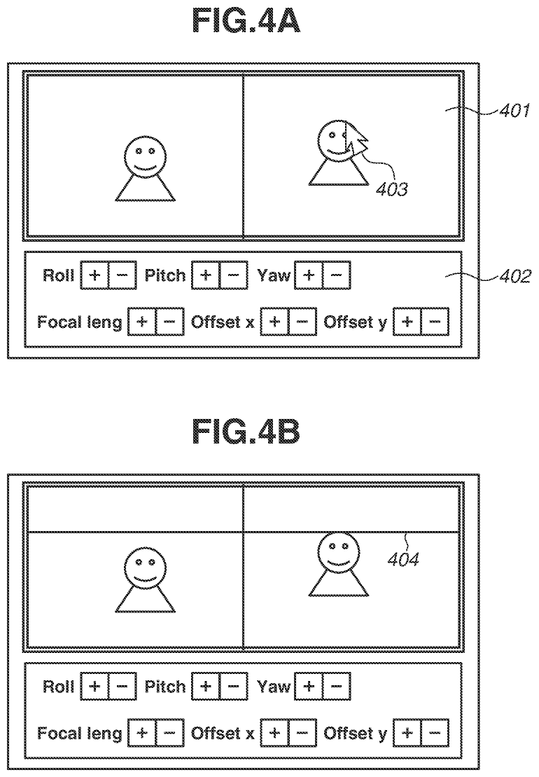

FIGS. 4A and 4B schematically illustrate a display screen to be presented to the user in the present exemplary embodiment. FIG. 4A illustrates an area where a stereo video image 401 is displayed. The stereo video image 401 illustrated in FIG. 4A is a stereo video image with parallax in a horizontal direction, and left and right video images are arranged side by side in the horizontal direction, that is, in the direction intersecting the vertical direction. Alternatively, a left-eye image and a right-eye image are arranged in each frame of a video image. Instead of arranging the left-eye image and the right-eye image in each frame, the left-eye image and the right-eye image that are arranged across a plurality of frames may be displayed on one screen.

A user interface (UI) 402 illustrated in FIG. 4A is used to correct camera parameters for one of the left-eye image and the right-eye image in the stereo video image. In FIGS. 4A and 4B, six items, i.e., “Roll”, “Pitch”, and “Yaw” for correcting the rotation of the camera, “Focal leng” for correcting the focal length of the camera, and “Offset x” and “Offset y” for correcting the optical center of the camera, are set as camera parameters.

The camera parameters can be corrected by clicking “+” or “−” for each item. If the user has corrected the camera parameters in the UI 402, the stereo video image corrected based on the set camera parameters is displayed as the stereo video image 401. For example, in a case where the camera parameters for the right-eye video image in the stereo video image are prepared in the UI 402, when “+” for “Roll” in the camera parameters is clicked, the video image rotated rightward with respect to the right-eye video image before correction is displayed.

The method of representing camera parameters and the method of displaying camera parameters are not limited to these examples, and various methods may be used. As another method of representing camera parameters, values corresponding to the respective items may be corrected by, for example, designating “Roll” as an angle. As another method of displaying camera parameters, camera parameters for each of the left-eye image and the right-eye image may be displayed, and the user may correct the camera parameters for each of the left-eye image and the right-eye image. In this case, the stereo video image 401 is displayed based on the corrected camera parameters for each of the left-eye image and the right-eye image.

A cursor 403 illustrated in FIG. 4A is operated by the user on the stereo video image displayed on the screen. If the user has performed an action, such as a click operation with a mouse, a guideline that passes through a cursor position pointed by the user is displayed as indicated by 404 in FIG. 4B. The guideline 404 is a horizontal straight line that is drawn across the left-eye video image and the right-eye video image in the stereo video image.

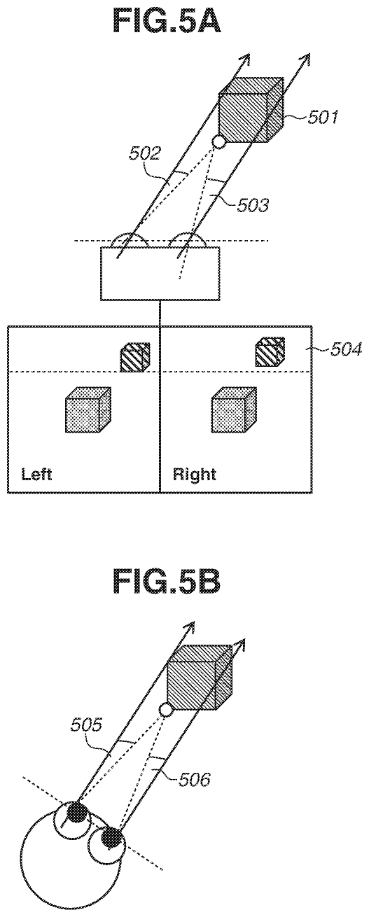

In general, an elevation/depression angle of one of left and right video images that is located closer to an object in a stereo video image obtained by capturing an image of a space is larger than that of the other of the left and right video images, which results in causing a deviation in the vertical direction in the stereo video image. For example, as illustrated in FIG. 5A, an elevation/depression angle 503 on the right side that is closer to an object 501 is larger than an elevation/depression angle 502 on the left side, which results in causing a deviation of the object 501 in the vertical direction in the stereo video image 504. Such a difference in the elevation/depression angle between the left and right video images increases in a direction away from the center.

For the user wearing a head-mounted display (HMD) to view video images in an excellent state in which the video images are fused in the HMD, it may be desirable that left and right elevation/depression angles (505 and 506) of the user wearing the HMD with respect to the object 501 match as illustrated in FIG. 5B. Accordingly, in a case where the user wearing the HMD views the stereo video image as illustrated in FIG. 5A, the left and right video images depicting the object 501 cannot be fused, which poses a problem if the object 501 is an important object to which a viewer is caused to pay attention.

As a countermeasure against this problem, a creator who has created the stereo video image may correct the stereo video image after capturing the stereo video image so as to prevent a deviation of the object 501 in the vertical direction from occurring. In this case, the display of the guideline according to the present exemplary embodiment described above enables the user or the creator who has created the stereo video image to easily determine whether a deviation of an important object to be selected by the user in the vertical direction has occurred. The outline and significance of the present exemplary embodiment has been described above.

Factors that cause a deviation in the vertical direction in the stereo video image are not limited to the above-described factors. Such a deviation may be caused by various factors such as a spatial deviation between left and right cameras when the cameras capture the stereo video image. The present exemplary embodiment can be applied to various factors.

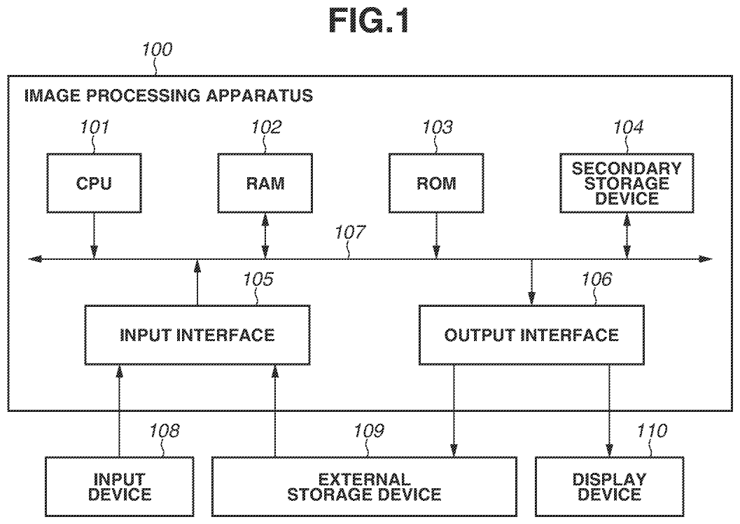

A specific configuration of the present exemplary embodiment will be described below. FIG. 1 is a block diagram illustrating a hardware configuration example of an image processing apparatus according to the first exemplary embodiment. As illustrated in FIG. 1, an image processing apparatus 100 according to the first exemplary embodiment includes a central processing unit (CPU) 101, a random access memory (RAM) 102, a read-only memory (ROM) 103, a secondary storage device 104, an input interface 105, and an output interface 106. The constituent units of the image processing apparatus 100 are interconnected via a system bus 107. The image processing apparatus 100 is connected to each of an input device 108 (e.g., a mouse, buttons, or a keyboard) and an external storage device 109 (e.g., a hard disk, a memory card, a compact flash (CF) card, a secure digital (SD) card, or a universal serial bus (USB) memory) via the input interface 105. The image processing apparatus 100 is connected to each of the external storage device 109 and a display device 110 via the output interface 106.

The CPU 101 is a processor that executes programs stored in the ROM 103 using the RAM 102 as a work memory, thereby controlling the constituent units of the image processing apparatus 100 in an integrated manner via the system bus 107. Thus, various processes to be described below are executed.

The secondary storage device 104 is a storage device that stores various data to be handled by the image processing apparatus 100. In the present exemplary embodiment, a hard disk drive (HDD) is used as the secondary storage device 104. The CPU 101 is configured to write data into the secondary storage device 104 and read out data stored in the secondary storage device 104 via the system bus 107. Not only the HDD, but also various storge devices, such as an optical disk drive and a flash memory, can be used as the secondary storage device 104.

The input interface 105 is, for example, a serial bus interface such as a USB or Institute of Electrical and Electronics Engineers (IEEE) 1394. Data, instructions, and the like are input to the image processing apparatus 100 from an external device via the input interface 105. The image processing apparatus 100 obtains data from the input device 108 and the external storage device 109 via the input interface 105.

The output interface 106 includes a serial bus interface, such as a USB or IEEE 1394, like the input interface 105. Additionally, for example, a video image output terminal such as a digital visual interface (DVI) or High Definition Multimedia Interface (HDMI®) can be used. Data and the like are output from the image processing apparatus 100 to an external device via the output interface 106. The image processing apparatus 100 outputs processed images and the like to the display device 110 (various image display devices such as a liquid crystal display) via the output interface 106, thereby displaying images. The image processing apparatus 100 may include any constituent element other than the above-described constituent elements.

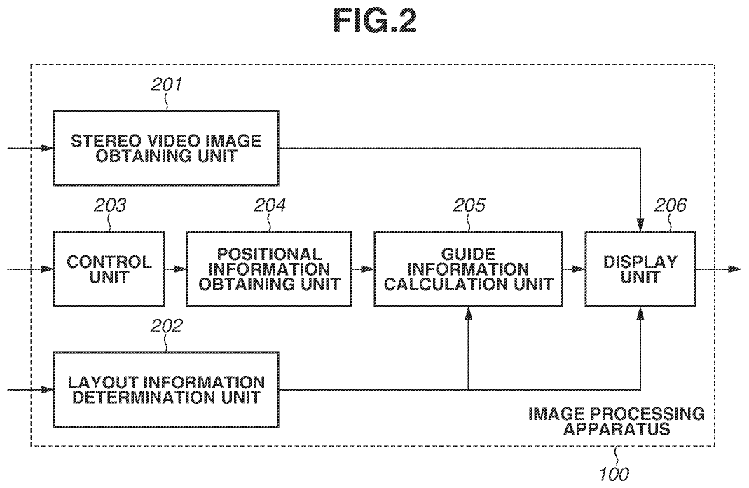

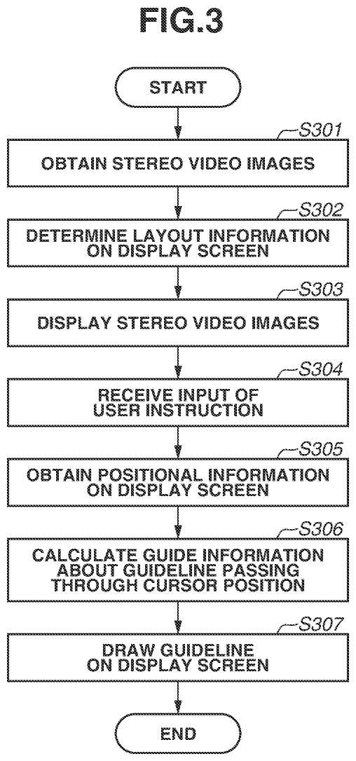

Processing to be performed by the image processing apparatus 100 according to the first exemplary embodiment will be described below with reference to FIGS. 2 and 3. FIG. 2 is a block diagram illustrating a functional configuration example of the image processing apparatus 100. The image processing apparatus 100 causes the CPU 101 to execute programs stored in the ROM 103 using the RAM 102 as a work memory, thereby functioning as constituent units illustrated in FIG. 2 and executing a series of processes illustrated in a flowchart of FIG. 3. There is no need for the CPU 101 to execute all the processes to be described below, and the image processing apparatus 100 may be configured such that some or all of the processes are executed by one or more processing circuits other than the CPU 101. A flow of processing to be performed by each constituent unit will be described.

In step S301, a stereo video image obtaining unit 201 obtains stereo video images on which camera parameters are to be corrected by the user via the input interface 105 or from the secondary storage device 104. In the present exemplary embodiment, assume that left and right video images each having parallax in the horizontal direction are obtained as stereo video images. However, the stereo video images are not limited to this example. The present exemplary embodiment can also be applied to a case where upper and lower video images each having parallax in the vertical direction are obtained as stereo video images. The stereo video image obtaining unit 201 outputs the obtained stereo video images to a display unit 206.

In step S302, a layout information determination unit 202 determines layout information on the display screen concerning the stereo video images and a graphical user interface (GUI) for correcting the camera parameters as illustrated in FIGS. 4A and 4B. The layout information according to the present exemplary embodiment is coordinate position information on the display screen concerning the stereo video image and the GUI for correcting the camera parameters.

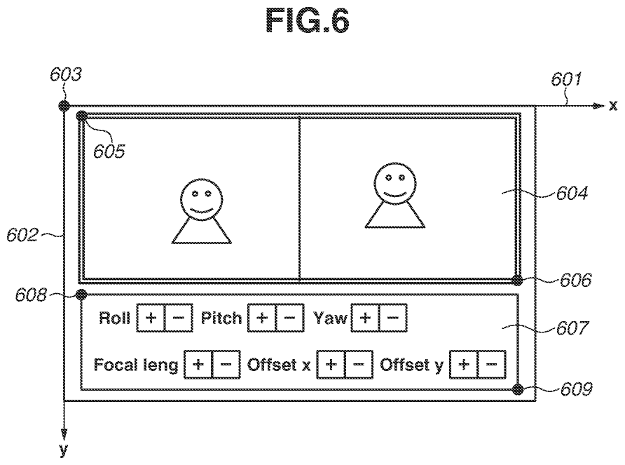

As illustrated in FIG. 6, the coordinate position information according to the present exemplary embodiment is designated using xy coordinates when a lateral direction 601 on the display screen is defined as an x-axis, a longitudinal direction 602 on the display screen is defined as a y-axis, and an upper left point 603 on the display screen is defined as an origin. For example, coordinate position information of a stereo video image 604 is designated as a coordinate position (xst, yst) of an upper left point 605 and a coordinate position (xsb, ysb) of a lower right point 606. Coordinate position information of a GUI 607 for correcting camera parameters is designated as a coordinate position (xct, yct) of an upper left point 608 and a coordinate position (xcb, ycb) of a lower right point 609.

The layout information determination unit 202 outputs layout information including a set of the coordinate position information of each stereo video image and the coordinate position information of the GUI for correcting camera parameters to each of a guide information calculation unit 205 and the display unit 206. The method of representing coordinate position information of each item on the display screen for each stereo video image and the GUI is not limited to the method described above. Any other representation method may be used as long as coordinates on the display screen can be specified. If an item other than the above-described items is displayed on the display screen, the coordinate position information of this item is also determined and is included in the layout information. In the present exemplary embodiment, layout information that is preliminarily determined and stored in the external storage device 109 is used as the layout information. The layout information is not limited to this example, and may be designated by the user via the input device 108.

In step S303, the display unit 206 outputs the display screen including the stereo video images obtained from the stereo video image obtaining unit 201 and the GUI for correcting camera parameters to the display device 110 based on the above-described layout information. The stereo video images to be displayed are arranged such that the left and right video images are arranged side by side in the horizontal direction. If upper and lower video images each having parallax in the vertical direction are obtained as stereo video images, the stereo video images are arranged such that the upper and lower video images are arranged side by side in the vertical direction. As the stereo video images to be displayed, stereo video images that are appropriately transformed based on camera parameters stored in the second storage device 104 are displayed.

In step S304, a control unit 203 causes the input device 108 to receive an input of a user instruction as an instruction from the user via the input interface 105 serving as reception means. The input of a user instruction according to the present exemplary embodiment is a click operation on the display screen with a mouse. The control unit 203 outputs information obtained through the click operation to a positional information obtaining unit 204, and then the processing proceeds to step S304. The input of an instruction from the user is not limited to this example. Various methods such as a key input with a keyboard may be used.

In step S305, the positional information obtaining unit 204 obtains, as positional information, coordinate position information (xp, yp) on the display screen pointed by the user when the user has performed a click operation. The positional information obtaining unit 204 outputs the coordinate position information obtained as position obtaining means to the guide information calculation unit 205.

In step S306, the guide information calculation unit 205 serving as guide calculation means calculates guide information based on the layout information obtained from the layout information determination unit 202 and the coordinate position information obtained from the positional information obtaining unit 204. The guide information according to the present exemplary embodiment includes a start coordinate position and an end coordinate position of a guideline to be drawn on each stereo video image on the display screen. The x-axis value of the start coordinate position is determined using the x-axis value of an upper left coordinate position on the stereo video image in the layout information, and the y-axis value of the start coordinate position is determined using the y-axis value of a coordinate position pointed by the user. That is, the start coordinate position is represented as (xst, yp). The x-axis value of the end coordinate position is determined using the x-axis value of a lower right coordinate position on the stereo video image in the layout information, and the y-axis value of the end coordinate position is determined using the y-axis value of a coordinate position pointed by the user. That is, the end coordinate position is represented as (xsd, yp). The guide information calculation unit 205 outputs the calculated guide information to the display unit 206.

In step S307, the display unit 206 draws a guideline on the display screen based on the guide information obtained from the guide information calculation unit 205. Then, the processing in this flowchart ends.

The above-described processing is performed by the image processing apparatus 100 according to the present exemplary embodiment.

In the present exemplary embodiment, in the case of correcting the position of the camera that has captured the left and right video images included in the stereo video image, the guideline is displayed on the stereo video image according to a cursor position pointed by the user on the display screen. This configuration enables the user to easily determine whether the camera position is corrected as intended by the user.

The first exemplary embodiment described above illustrates a method in which a guideline that passes through a cursor position pointed by the user on the display screen is displayed on a stereo video image in the case of correcting the position of the camera that has captured left and right video images included in the stereo video image.

In a second exemplary embodiment, processing for detecting feature points present in the vicinity of a cursor position pointed by the user in a stereo video image is added, and a guideline that passes through the detected feature points is displayed on the stereo video image. In the first exemplary embodiment, it may be difficult to determine the degree of deviation in the vertical direction in a stereo video image depending on the cursor position pointed by the user. For example, if the user points a cursor at a position on a person's face in a stereo video image including a person, the guideline is displayed at various positions, for example, at positions corresponding to person's eyes, or at a position between the eyes and nose of a person, depending on the cursor position pointed by the user. If the user determines the degree of deviation in the vertical direction in the stereo video image, the guideline displayed at positions corresponding to person's eyes is more advantageous than the guideline displayed at a position between the person's eyes and nose. Accordingly, in the second exemplary embodiment, the display of the guideline that passes through feature points present in the vicinity of a cursor position pointed by the user enables the user to easily determine whether the camera position is corrected as intended by the user, regardless of the accuracy of the cursor position pointed by the user.

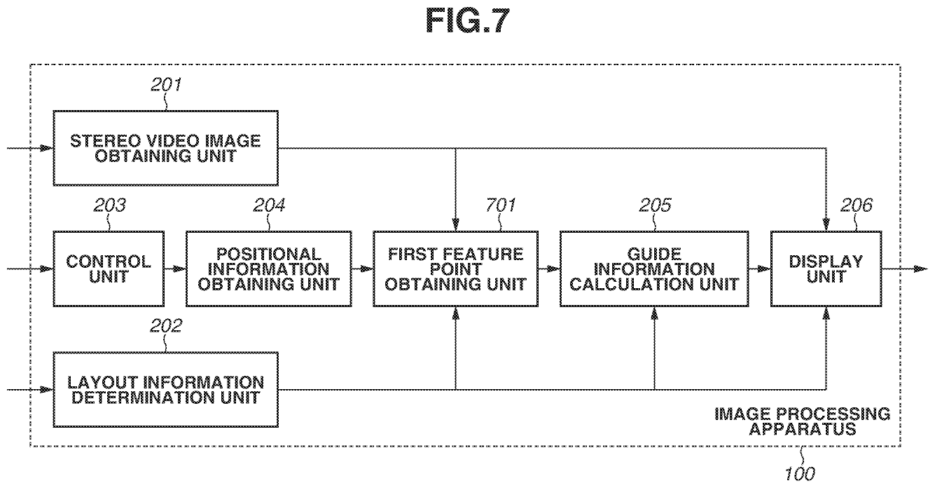

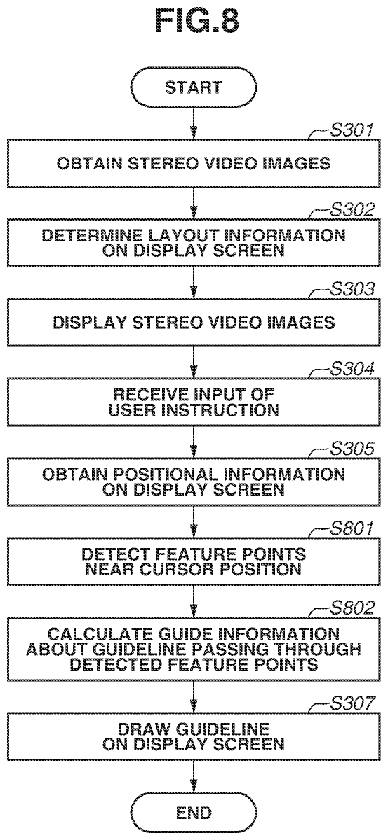

Processing to be performed by the image processing apparatus 100 according to the present exemplary embodiment will be described below. FIG. 1 is a block diagram illustrating a functional configuration example of the image processing apparatus 100 according to the present exemplary embodiment. The image processing apparatus 100 causes the CPU 101 to execute programs stored in the ROM 103 using the RAM 102 as a work memory, thereby functioning as constituent units illustrated in FIG. 7 and executing a series of processes illustrated in the flowchart of FIG. 8. There is no need for the CPU 101 to execute all the processes to be described below, and the image processing apparatus 100 may be configured such that some or all of the processes are executed by one or more processing circuits other than the CPU 101. Components and processes similar to those of the first exemplary embodiment are denoted by the same reference numerals and the same step numbers, respectively, of the first exemplary embodiment, and descriptions thereof are omitted.

Differences in the relationship among the constituent elements between the first exemplary embodiment and the second exemplary embodiment will now be described. The stereo video image obtaining unit 201 outputs the obtained stereo video images not only to the display unit 206, but also to a first feature point obtaining unit 701. The positional information obtaining unit 204 outputs the coordinate position information to the first feature point obtaining unit 701.

The layout information determination unit 202 outputs the layout information not only to the guide information calculation unit 205 and the display unit 206, but also to the first feature point obtaining unit 701.

The component and processes that are newly added in the second exemplary embodiment will be described below.

In step S801, the first feature point obtaining unit 701 detects feature points present in the vicinity of the coordinate position pointed by the user on the display screen in each stereo video image obtained from the stereo video image obtaining unit 201. This processing method will be described in detail below.

First, the first feature point obtaining unit 701 obtains coordinates of a pixel of interest on the stereo video image corresponding to the coordinate position information obtained from the positional information obtaining unit 204 from the layout information obtained from the layout information determination unit 202. The coordinates of the pixel of interest on the stereo video image can be calculated based on the relationship among the upper left coordinate position (xst, yst) and the lower right coordinate position (xsb, ysb) on the stereo video image in the layout information and the coordinate position (xp, yp) on the display screen pointed by the user as the coordinate position information. In the present exemplary embodiment, the coordinates of the pixel of interest are designated as pixel coordinates when an upper left point is defined as an origin, the lateral direction is defined as a u-axis, and the longitudinal direction is defined as a v-axis on the stereo video images arranged side by side in the horizontal direction, like the stereo video images displayed on the display screen. When the lateral direction and the longitudinal direction of the stereo video images arranged side by side in the horizontal direction are represented as “width” and “height”, respectively, as the image size of the stereo video images, the coordinates of the pixel of interest are represented as (xp×width/(xsb−xst), yp×height/(ysb−yst)).

The representation method used for designating pixel coordinates is not limited to this example, and any representation method may be used, as long as a pixel position on a stereo video image can be designated.

Next, the first feature point obtaining unit 701 detects feature points that are included in the stereo video images and are present in the vicinity of the calculated coordinates of the pixel of interest on the stereo video images. To detect feature points, an area centered on the coordinates of the pixel of interest on the stereo video images is defined as a partial area, and a set of pixel coordinates of the feature points are calculated by a method, such as scale invariant feature transform (SIFT), within the area. The number of feature points obtained as the set of pixel coordinates varies depending on an object captured in the stereo video images, and the number of feature points increases as the object has a finer pattern. The method for detecting feature points is not limited to this example, and any other method may be used.

Further, the first feature point obtaining unit 701 detects representative pixel coordinates (ut, vt) of the feature point having pixel coordinates closest to the coordinates of the pixel of interest from the set of pixel coordinates of the obtained feature points.

Lastly, the first feature point obtaining unit 701 outputs the coordinate position of the feature point obtained by transforming the detected representative pixel coordinates (ut, vt) into the coordinate position on the display screen as feature point information to the guide information calculation unit 205. The coordinate position of the feature point can be calculated as (ut×(xsb−xst)/width, vt×(ysb−yst)/height).

In step S802, the guide information calculation unit 205 calculates guide information based on the coordinate position of the feature point obtained from the feature point obtaining unit 701. The guide information according to the present exemplary embodiment includes a start coordinate position and an end coordinate position of a guideline to be drawn on each stereo video image on the display screen, like in the first exemplary embodiment. The x-axis value of the start coordinate position is determined using the x-axis value of an upper left coordinate position on the stereo video image in the layout information, and the y-axis value of the start coordinate position is determined using the y-axis value of the coordinate position of the feature point. The guide information calculation unit 205 outputs the calculated guide information to the display unit 206.

The above-described processing is performed by the image processing apparatus 100 according to the second exemplary embodiment. In the second exemplary embodiment, a first feature point detection unit is added to the configuration according to the first exemplary embodiment, and processing for detecting feature points present in the vicinity of a position pointed by the user on the stereo video image is added. In the second exemplary embodiment, the display of a guideline that passes through feature points present in the vicinity of a cursor position pointed by the user enables the user to easily determine whether the camera position is corrected as intended by the user, regardless of the accuracy of the cursor position pointed by the user.

In the second exemplary embodiment, processing for detecting feature points on stereo video images that are present in the vicinity of a cursor position pointed by the user is added, and a method for displaying a guideline passing through the detected feature points on the stereo video images has been described.

In a third exemplary embodiment, processing for detecting a second feature point corresponding to a first feature point on a stereo video image that is present in the vicinity of a cursor position pointed by the user is added, and a guideline that passes through the first feature point and the second feature point is displayed on the stereo video image. For example, if the cursor position pointed by the user is on the right-eye video image in the stereo video image, the first feature point on the right-eye video image is detected and the second feature point corresponding to the first feature point is detected on the left-eye video image. Then, a straight line that passes through the first feature point and the second feature point is displayed as a guideline. This configuration enables the user to recognize whether a deviation in the vertical direction in the stereo video image has occurred by checking whether the guideline is horizontal. Consequently, the user can easily determine whether the camera position is corrected as intended by the user.

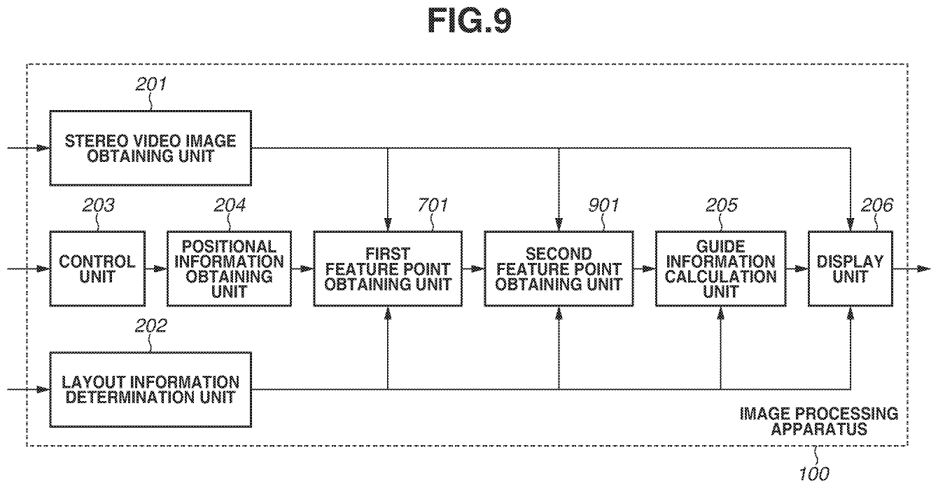

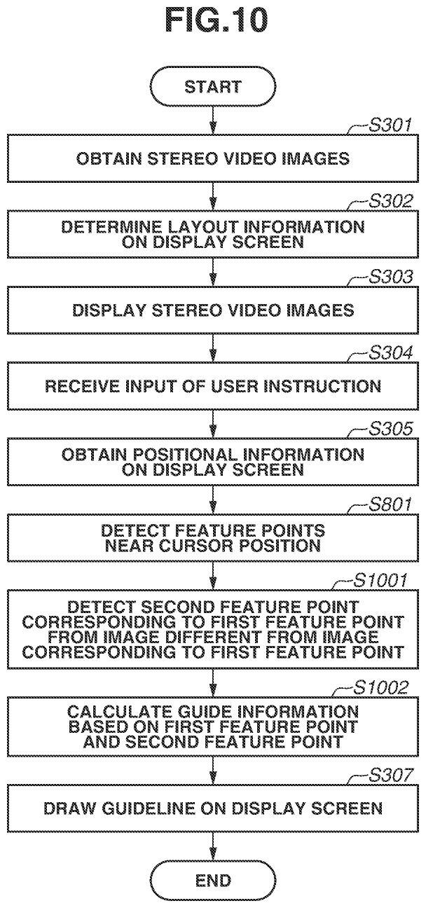

Processing to be performed by the image processing apparatus 100 according to the third exemplary embodiment will be described below. FIG. 1 is a block diagram illustrating a functional configuration example of the image processing apparatus 100 according to the present exemplary embodiment. The image processing apparatus 100 executes programs stored in the ROM 103 using the RAM 102 as a work memory, thereby functioning as constituent units illustrated in FIG. 9 and executing a series of processes illustrated in a flowchart of FIG. 10. There is no need for the CPU 101 to execute all the processes to be described below, and the image processing apparatus 100 may be configured such that some or all of the processes are executed by one or more processing circuits other than the CPU 101. Components and processes similar to those of the first and second exemplary embodiments are denoted by the same reference numerals and the same step numbers, respectively, of the first and second exemplary embodiments, and descriptions thereof are omitted.

Differences in the relationship among the constituent elements between the third exemplary embodiment and the first and second exemplary embodiments will now be described. The stereo video image obtaining unit 201 outputs the obtained stereo video images not only to the first feature point obtaining unit 701 and the display unit 206, but also to a second feature point obtaining unit 901. The positional information obtaining unit 204 outputs the coordinate position information to the first feature point obtaining unit 701. The layout information determination unit 202 outputs the layout information not only to the first feature point obtaining unit 701, the guide information calculation unit 205, and the display unit 206, but also to the second feature point obtaining unit 901. The first feature point obtaining unit 701 outputs the feature point information to the second feature point obtaining unit 901.

The component and processes that are newly added in the third exemplary embodiment will be described below.

In step S1001, the second feature point obtaining unit 901 detects a second feature point corresponding to the first feature point obtained from the first feature point obtaining unit 701 in the stereo video images obtained from the stereo video image obtaining unit 201. This processing method will be described in detail below.

First, the second feature point obtaining unit 901 determines whether the first feature point corresponds to a feature point on which one of the left-eye video image and the right-eye video image in the stereo video image based on the feature point information obtained from the first feature point obtaining unit 701. Specifically, if the x-axis value of a coordinate position (xf, yf) of the first feature point displayed on the display screen as feature point information is present on the right side with respect to the center of the area of the stereo video image within the display screen, the first feature point is regarded as a feature point corresponding to the right-eye video image. If the x-axis value of the coordinate position (xf, yf) is present on the left side, the first feature point is regarded as a feature point corresponding to the left-eye video image. While the third exemplary embodiment to be described below illustrates an example where the first feature point is a feature point corresponding to the right-eye video image, the third exemplary embodiment can also be applied to a case where the first feature point is a feature point corresponding to the left-eye video image.

Next, the second feature point obtaining unit 901 transforms a coordinate position (xf1, yf1) of the first feature point on the display screen into pixel coordinates on the stereo video image. Like in the second exemplary embodiment, the coordinate position of the first feature point can be calculated based on the relationship among the upper left coordinate position (xst, yst) and the lower right coordinate position (xsb, ysb) on the stereo video image in the layout information and the coordinate position (xf1, yf1) of the first feature point. That is, the pixel coordinates (uf1, vf1) of the first feature point are represented as (xf1×width/(xsb−xst), yf1× height/(ysb−yst)).

Further, the second feature point obtaining unit 901 calculates the coordinates of the pixel of interest on the left-eye video image based on the pixel coordinates (uf1, vf1) of the first feature point. The coordinates of the pixel of interest are calculated by subtracting the value of a half of the width of the stereo video image from the u-axis value of the pixel coordinates of the first feature point as represented by (uf1-width/2, vf1). If the first feature point is a point corresponding to the left-eye video image, the value of a half of the width of the stereo video image is added. The second feature point obtaining unit 901 detects a feature point in the vicinity of the coordinates of the pixel of interest that corresponds to a feature within the stereo video image and is present in the vicinity of the pixel coordinates of the first feature point. To detect the corresponding feature point, a general method for associating feature points between two images may be used. In the present exemplary embodiment, pixel coordinates (uf2, vf2) of the corresponding feature point are used as the pixel coordinates of the second feature point.

Lastly, the second feature point obtaining unit 901 transforms the pixel coordinates (uf2, vf2) of the second feature point into the coordinate position on the display screen. Like in the second exemplary embodiment, the transformed coordinate position of the second feature point can be calculated as (uf2×(xsb−xst)/width, vf2×(ysb−yst)/height). The second feature point obtaining unit 901 outputs information including a set of the coordinate position of the first feature point and the coordinate position of the second feature point as feature point information to the guide information calculation unit 205.

In step S1002, the guide information calculation unit 205 calculates guide information based on the feature point information obtained from the second feature point obtaining unit 901. The guide information according to the present exemplary embodiment includes a start coordinate position and an end coordinate position of a guideline to be drawn on each stereo video image on the display screen, like in the first exemplary embodiment. The start coordinate position corresponds to the coordinate position of the second feature point in the feature point information, and the end coordinate position corresponds to the coordinate position of the first feature point in the feature point information. If the first feature point is a feature point on the left-eye video image, the start coordinate position corresponds to the coordinate position of the first feature point, and the end coordinate position corresponds to the coordinate position of the second feature point. The guide information calculation unit 205 outputs the calculated guide information to the display unit 206.

The above-described processing is performed by the image processing apparatus 100 according to the third exemplary embodiment. In the third exemplary embodiment, the second feature point obtaining unit 901 is added to the configuration according to the second exemplary embodiment, and processing for obtaining the second feature point on each stereo video image that corresponds to the first feature point is added. In the third exemplary embodiment, the display of a guideline that passes through feature points present in the vicinity of a cursor position pointed by the user enables the user to easily determine whether the camera position is corrected as intended by the user.

### Other Exemplary Embodiments

Exemplary embodiments of the present disclosure are not limited only to the above-described exemplary embodiments, and various exemplary embodiments can be implemented. For example, while the third exemplary embodiment illustrates an example where a guideline that connects feature points is used as guide information, the guide information is not limited to this example. A value indicating an amount of deviation in the vertical direction between the first feature point and the second feature point may be output as guide information. Further, in the third exemplary embodiment, if the amount of deviation in the vertical direction between the first feature point and the second feature point is “0”, the color of the guideline to be displayed may be changed.

Furthermore, the guideline according to the second exemplary embodiment and the guideline according to the third exemplary embodiment may be used in combination to simultaneously display two types of guidelines, i.e., a straight line that passes through only the first feature point and is parallel to the direction of the stereo video image and a straight line that passes through the first feature point and the second feature point, on the display screen.

While the second and third exemplary embodiments illustrate an example where only the feature point closest to the coordinate position pointed by the user is detected and the guideline that passes through the detected feature point is displayed, a plurality of guidelines that pass through a plurality of feature points may be displayed for each of the plurality of feature points.

As a modified example of the second and third exemplary embodiments, the second feature point obtaining unit 901 may obtain the second feature point corresponding to the first feature point in a stereo video image that is different in chronological order from the stereo video image in which the first feature point is detected. For example, when a frame of the stereo video image in which the first feature point is obtained is represented by t0, the second feature point corresponding to the feature point in a stereo video image of a frame t1 that is not identical to the frame t0 and is subsequent to the frame t0 is detected. In this case, in the stereo video image of the frame t1, a feature point that is present in the vicinity of a coordinate position similar to the coordinate position of the first feature point, which is the feature point information obtained from the first feature point obtaining unit 701, is detected. Then, the detected feature point is set as the second feature point and the coordinate position of the second feature point on the display screen is output as the feature point information to the guide information calculation unit 205. The guide information calculation unit 205 outputs guide information for displaying a guideline that passes through the coordinate position of the second feature point obtained as the feature point information to the display unit 206. Consequently, when an object of interest to the user is designated in a specific frame of the stereo video image, a guideline that follows the designated object can be displayed during replay of a moving image.

The present disclosure can also be implemented by the following processing. That is, a program for implementing one or more functions according to the exemplary embodiments described above is supplied to a system or an apparatus via a network or a storage medium, and one or more processors in a computer of the system or the apparatus read out and execute the program. The present disclosure can also be implemented by a circuit (e.g., an application-specific integrated circuit (ASIC)) for implementing one or more functions according to the exemplary embodiments described above.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

An image processing apparatus according to an exemplary embodiment of the present disclosure enables a user to easily recognize whether a stereo video image is appropriately corrected.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-059529, filed Mar. 31, 2023, which is hereby incorporated by reference herein in its entirety.

What is claimed is:

1. An image processing apparatus comprising:
a video image obtaining unit configured to obtain video data corresponding to a stereo video image including a left-eye image and a right-eye image; and
a control unit configured to control guide information and the stereo video image to be displayed based on the video data, the guide information varying depending on a position on the stereo video image and indicating a deviation between the left-eye image and the right-eye image in a vertical direction.

2. The image processing apparatus according to claim 1, further comprising a position obtaining unit configured to obtain positional information indicating a position on the stereo video image,
wherein the control unit includes a guide calculation unit configured to calculate the guide information varying depending on the positional information, and controls a display unit to display the calculated guide information and the stereo video image.

3. The image processing apparatus according to claim 1, wherein the guide information is information indicating the deviation in a partial area including a position indicated by positional information.

4. The image processing apparatus according to claim 3, wherein the guide information is a horizontal straight line passing through the partial area.

5. The image processing apparatus according to claim 1, wherein the control unit controls the left-eye image and the right-eye image to be displayed such that the left-eye image and the right-eye image are arranged side by side in a direction perpendicular to the vertical direction.

6. The image processing apparatus according to claim 1, wherein the guide information is information indicating a guide to correct the deviation, instead of indicating the deviation.

7. The image processing apparatus according to claim 1, wherein the guide information is not only information indicating the deviation, but also information indicating a guide to correct the deviation.

8. The image processing apparatus according to claim 1,
wherein the control unit includes a reception unit configured to receive a user instruction to display the guide information, and
wherein the control unit displays the guide information upon reception of the user instruction.

9. The image processing apparatus according to claim 3, further comprising a first obtaining unit configured to obtain a feature point representing a feature in the stereo video image, the feature point being present in the partial area.

10. The image processing apparatus according to claim 9, further comprising a second obtaining unit configured to obtain a second feature point corresponding to the feature point from the video data,
wherein the control unit displays the guide information based on the second feature point.

11. The image processing apparatus according to claim 10,
wherein the second feature point is obtained in a stereo video image of a frame identical to the frame of the stereo video image in which the feature point obtained by the first obtaining unit is present, and
wherein the control unit displays, as the guide information, information for displaying a straight line passing through the feature point obtained by the first obtaining unit and the second feature point.

12. The image processing apparatus according to claim 10,
wherein the second feature point is obtained in a stereo video image of a frame different from a frame of the stereo video image in which the feature point obtained by the first obtaining unit is present, and
wherein the control unit displays, as the guide information, information for displaying a horizontal straight line passing through the second feature point.

13. An image processing method comprising:
obtaining video data corresponding to a stereo video image including a left-eye image and a right-eye image; and
controlling guide information and the stereo video image to be displayed based on the video data, the guide information varying depending on a position on the stereo video image and indicating a deviation between the left-eye image and the right-eye image in a vertical direction.

14. A non-transitory computer-readable storage medium storing instructions which, when executed by a computer, cause the computer to perform a method comprising:
obtaining video data corresponding to a stereo video image including a left-eye image and a right-eye image; and
controlling guide information and the stereo video image to be displayed based on the video data, the guide information varying depending on a position on the stereo video image and indicating a deviation between the left-eye image and the right-eye image in a vertical direction.
